(19) United States
(12) Patent Application Publication
(10) Pub. No.: US 2024/0284391 A1
(43) Pub. Date: Aug. 22, 2024

(54) POSITIONING METHOD AND APPARATUS, AND RELATED DEVICE

(71) Applicant: VIVO MOBILE COMMUNICATION CO., LTD., Dongguan (CN)

(72) Inventors: Ye SI, Dongguan (CN); Huaming WU, Dongguan (CN); Yuanyuan WANG, Dongguan (CN); Zixun ZHUANG, Dongguan (CN)

(73) Assignee: VIVO MOBILE COMMUNICATION CO., LTD., Dongguan (CN)

(21) Appl. No.: 18/650,236

(22) Filed: Apr. 30, 2024

Related U.S. Application Data
(63) Continuation of application No. PCT/CN2022/129060, filed on Nov. 1, 2022.

(30) Foreign Application Priority Data
Nov. 3, 2021 (CN) 202111295255.1

(51) Int. Cl. H04W 64/00; H04L 5/00; H04W 8/22; H04W 24/10

(52) U.S. Cl. CPC H04W 64/00; H04L 5/0051; H04W 8/22; H04W 24/10

(57) ABSTRACT

A positioning method and apparatus, and a related device are provided. The method includes: obtaining target information by a first network device, and initiating a positioning procedure based on the target information by the first network device. The positioning procedure includes at least one of the following: sending target indication information to a second network device or a terminal, sending Positioning Reference Signal (PRS) positioning assistance data to the terminal, sending a location information request to the terminal, or performing location calculation. The target indication information is used to indicate a PRS measurement manner of the terminal. The location information request is used to request a PRS measurement result of the terminal. The location calculation is used to calculate a location of the terminal.

### CROSS-REFERENCE TO RELATED APPLICATIONS

This application is a continuation of International Application No. PCT/CN2022/129060, filed on Nov. 1, 2022, which claims priority to Chinese Patent Application No. 202111295255.1, filed on Nov. 3, 2021. The entire contents of each of the above-referenced applications are expressly incorporated herein by reference.

### TECHNICAL FIELD

This application pertains to the field of communication technologies, and specifically relates to a positioning method and apparatus, and a related device.

### BACKGROUND

In the prior art, a downlink Positioning Reference Signal (PRS) based on a New Radio (NR) system is re-designed, for a terminal to perform positioning measurement. To complete positioning, the terminal needs to measure PRSs sent by a plurality of cells. The terminal may measure a PRS sent by a non-serving cell. In consideration of possible non-synchronization between a non-serving cell and a serving cell, the current manner of positioning the terminal may cause a problem that the terminal has poor positioning performance.

### SUMMARY

Embodiments of this application provide a positioning method and apparatus, and a related device.

According to a first aspect, a positioning method is provided, including:

A first network device obtains target information; and
the first network device initiates a positioning procedure according to the target information, where
the positioning procedure includes at least one of the following:
sending target indication information to a second network device and/or a terminal, where the target indication information is used to indicate a positioning reference signal PRS measurement manner of the terminal;
sending PRS positioning assistance data to the terminal;
sending a location information request to the terminal, where the location information request is used to request a PRS measurement result of the terminal; and
performing location calculation, where the location calculation is used to calculate a location of the terminal.

According to a second aspect, a positioning apparatus is provided, including:
an obtaining module, configured to obtain target information; and
an initiation module, configured to initiate a positioning procedure according to the target information, where
the positioning procedure includes at least one of the following:
sending target indication information to a second network device and/or a terminal, where the target indication information is used to indicate a positioning reference signal PRS measurement manner of the terminal;
sending PRS positioning assistance data to the terminal;
sending a location information request to the terminal, where the location information request is used to request a PRS measurement result of the terminal; and
performing location calculation, where the location calculation is used to calculate a location of the terminal.

According to a third aspect, a network side device is provided, including a processor, a memory, and a program or an instruction that is stored in the memory and that can be run on the processor, where when the program or the instruction is executed by the processor, the steps of the positioning method in the first aspect are implemented.

According to a fourth aspect, a readable storage medium is provided. The readable storage medium stores a program or an instruction, where when the program or the instruction is executed by a processor, the steps of the positioning method according to the first aspect are implemented.

According to a fifth aspect, a chip is provided. The chip includes a processor and a communication interface, the communication interface is coupled to the processor, and the processor is configured to run a program or an instruction of a network side device to implement the positioning method according to the first aspect.

In the embodiments of this application, the first network device obtains target information; and the first network device initiates a positioning procedure based on the target information, where the positioning procedure includes at least one of the following: sending target indication information to a second network device and/or a terminal, where the target indication information is used to indicate a positioning reference signal PRS measurement manner of the terminal; sending PRS positioning assistance data to the terminal; sending a location information request to the terminal, where the location information request is used to request a PRS measurement result of the terminal; and performing location calculation, where the location calculation is used to calculate a location of the terminal. The foregoing manner facilitates positioning by the terminal, to improve positioning performance.

### BRIEF DESCRIPTION OF DRAWINGS

FIG. 1 is a structural diagram of a network system according to an embodiment of this application;

FIG. 2 is a flowchart of a positioning method according to an embodiment of this application;

FIG. 3 is a structural diagram of a positioning apparatus according to an embodiment of this application;

FIG. 4 is a structural diagram of a communication device according to an embodiment of this application; and

FIG. 5 is a structural diagram of a network side device according to an embodiment of this application.

### DETAILED DESCRIPTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first,” “second,” and the like in this specification and claims of this application are used to distinguish between similar objects instead of describing a specific order or sequence. It should be understood that, data termed in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects. “Transmission” in this application means signal transmission, instead of signal sending in the narrow sense.

It should be noted that, the technologies described in the embodiments of this application are not limited to a Long Term Evolution (LTE)/LTE-Advanced (LTE-A) system, and may also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. However, an NR system is described in the following description for illustrative purposes, and the NR terminology is used in most of the following description, although these technologies can also be applied to applications other than the NR system application, such as the 6^{th} Generation (6G) communication system.

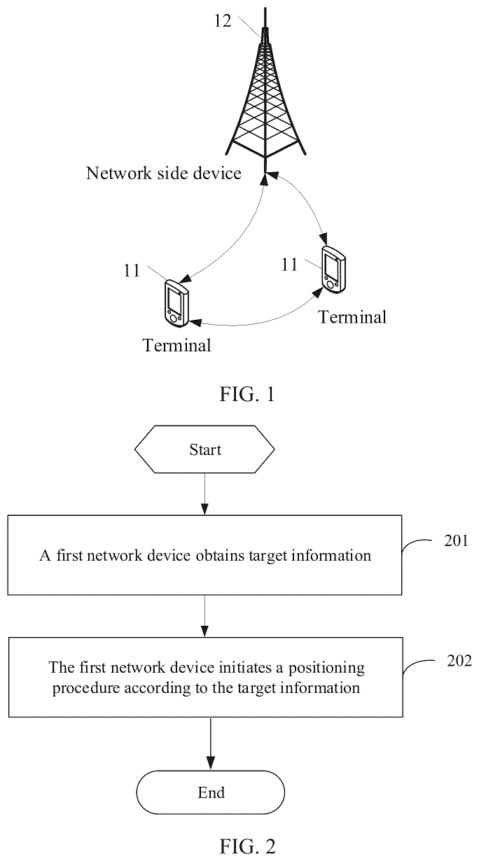

FIG. 1 is a structural diagram of a wireless communication system to which embodiments of this application are applicable. The wireless communication system includes a terminal 11 and a network side device 12. The terminal 11 may also be referred to as a terminal device or User Equipment (UE). The terminal 11 may be a terminal side device such as a mobile phone, a tablet computer, a laptop computer or a notebook computer, a Personal Digital Assistant (PDA), a palmtop computer, a netbook, an Ultra-Mobile Personal Computer (UMPC), a Mobile Internet Device (MID), a wearable device, Vehicle User Equipment (VUE), or Pedestrian User Equipment (PUE). The wearable device includes a bracelet, a headset, glasses, and the like. It should be noted that a specific type of the terminal 11 is not limited in the embodiments of this application. The network side device 12 may be a base station or a core network. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a WLAN access point, a Wi-Fi node, a Transmission and Reception Point (TRP), or another suitable term in the field provided that same technical effect is achieved. The base station is not limited to a specific technical term. It should be noted that, in the embodiments of this application, only a base station in an NR system is used as an example, but a specific type of the base station is not limited.

With reference to the accompanying drawings, a positioning method provided in the embodiments of this application is described in detail by using embodiments and application scenarios.

With reference to FIG. 2, FIG. 2 is a flowchart of a positioning method according to an embodiment of this application. The positioning method includes:

Step 201: A first network device obtains target information.

Step 202: The first network device initiates a positioning procedure according to the target information.

The positioning procedure includes at least one of the following:
sending target indication information to a second network device and/or a terminal, where the target indication information is used to indicate a PRS measurement manner of the terminal;
sending PRS positioning assistance data to the terminal;
sending a location information request to the terminal, where the location information request is used to request a PRS measurement result of the terminal; and
performing location calculation, where the location calculation is used to calculate a location of the terminal.

In the foregoing description, the first network device may be a location server, and the second network device may be a (serving) base station. The first network device may determine, based on the target information, whether a non-serving cell of the terminal meets a PRS measurement condition of the terminal, and initiate the positioning procedure based on a determining result. The PRS measurement condition includes but is not limited to: A receive timing difference between the non-serving cell of the terminal and a serving cell of the terminal is less than or equal to a target timing difference threshold. The target timing difference threshold may be obtained in at least one of the manners: protocol agreement, indication by another node, and terminal capability reporting. The PRS measurement condition may also be indicated as a PRS synchronization condition. The non-serving cell of the terminal may also be indicated as a neighboring cell of the terminal.

In some embodiments, that the receive timing difference between the non-serving cell of the terminal and the serving cell of the terminal is less than or equal to the target timing difference threshold may be understood as follows:

A timing difference between timing of the non-serving cell of the terminal and timing of the serving cell of the terminal is less than or equal to the target timing difference threshold; or, a receive timing difference between receive timing of the non-serving cell of the terminal and receive timing of the serving cell of the terminal is less than or equal to the target timing difference threshold; or, a receive timing difference between a PRS of the non-serving cell of the terminal and a PRS of the serving cell is less than or equal to the target timing difference threshold; or a receive timing difference between the PRS of the non-serving cell of the terminal and the PRS of the serving cell is less than or equal to the target timing difference threshold.

In this embodiment, the first network device obtains target information; and the first network device initiates a positioning procedure based on the target information, where the positioning procedure includes at least one of the following: sending target indication information to a second network device and/or a terminal, where the target indication information is used to indicate a positioning reference signal PRS measurement manner of the terminal; sending PRS positioning assistance data to the terminal; sending a location information request to the terminal, where the location information request is used to request a PRS measurement result of the terminal; and performing location calculation, where the location calculation is used to calculate a location of the terminal. The foregoing manner facilitates positioning by the terminal, to improve positioning performance.

In this application, measurement of the PRS by using an active Bandwidth Part (BWP) may be understood as “measurement of the PRS by using a PRS processing window,” or “measurement of the PRS in an MG-less (no MG) case,” or “measurement of the PRS in a Measurement Gap (MG)-less case,” or “measurement of the PRS outside the MG.”

In the foregoing description, the target information includes at least one of the following:
related information of a serving cell;
capability information of the terminal; and
timing difference threshold information.

For example, the first network device determines, based on a UE capability (the UE supports processing of the PRS by using Fast Fourier Transform (FFT) or Discrete Fourier transform (DFT)), whether the receive timing difference between the non-serving cell of the terminal and the serving cell of the terminal meets the target timing difference threshold.

The related information of the serving cell may come from the second network device or the terminal, and the related information of the serving cell includes at least one of the following:
synchronization information of the serving cell;
timing information of the serving cell;
frequency domain location information of the serving cell;
identity information of the serving cell;
activation information of the serving cell;
deactivation information of the serving cell;
adding information of the serving cell; and
release information of the serving cell.

The serving cell includes at least one of: a primary cell, a primary secondary cell, and a secondary cell. The related information of the serving cell may include related information of at least one serving cell. At least one of the cells included in the serving cell is an activated serving cell, and/or, at least one of the cells included in the serving cell is a serving cell that has been added. The serving cell may be determined according to an indication of the first network device.

The synchronization information of the serving cell is, for example, in a case that the serving cell includes a plurality of cells, whether these cells are synchronous, or, in a case that the serving cell includes a primary cell and a primary secondary cell, whether the primary cell is synchronous with the primary secondary cell, or, in a case that the serving cell includes a primary cell and a secondary cell, whether the secondary cell is synchronous with the primary cell, or, in a case that the serving cell includes a primary secondary cell and a secondary cell, whether the secondary cell is synchronous with the primary secondary cell.

In the foregoing description, the timing information of the serving cell includes at least one of the following:
a timing difference between the serving cell and the primary cell (or the primary secondary cell), for example, ca-SlotOffset, where, if the serving cell and the primary cell (or the primary secondary cell) are synchronous, a reporting difference is 0, or a default indication is provided (the first network device assumes that a timing difference between the serving cell and the primary cell (or the primary secondary cell) is 0), where ca-SlotOffset is the timing difference between the serving cell and the primary cell (or the primary secondary cell) with a granularity of Slot, and ca-SlotOffset in an RRC message may be multiplexed;
an offset between a system frame 0 (which may be understood as the 0^{th} system frame) of the serving cell and a system frame 0 (System Frame Number, SFN0) of the primary cell (or the primary secondary cell), for example, an offset with a granularity of a UTC level; and
an absolute time of the system frame 0 of the serving cell.

In some embodiments, for the timing information of the serving cell, the serving cell may include a plurality of cells, and the plurality of cells correspond to different bands. In some embodiments, if cells corresponding to a same band are synchronous, the second network device or the UE only needs to provide timing information of any cell that is located on a band different from that of the primary cell (or the primary secondary cell). In some embodiments, cells corresponding to bands include (all or some of) activated serving cells, and/or cells corresponding to bands include (all or some of) serving cells that have been added.

In some embodiments, information about the some serving cells may be indicated by the first network device, or may be obtained by requesting the second network device or the terminal.

In the foregoing description, the frequency domain location information of the serving cell includes at least one of the following:
a frequency location of the serving cell, for example, an Absolute Radio Frequency Channel Number (ARFCN);
a center frequency location of the serving cell;
a carrier bandwidth of the serving cell;
a reference point of the serving cell, for example, a point-A;
a Subcarrier Spacing (SCS) supported by the serving cell;
a carrier range of the serving cell; and
a band indicator corresponding to the serving cell.

In the foregoing description, the identity information of the serving cell includes at least one of the following:
a serving cell identity, namely, a serving cell ID, corresponding to the serving cell;
a Component Carrier (CC) Identifier, namely, a CCID, corresponding to the serving cell;
a NR Cell Global Identifier (NCGI) corresponding to the serving cell;
a Physical Cell Identifier (PCI) corresponding to the serving cell; and
a band indicator corresponding to the serving cell.

For the activation information of the serving cell and the deactivation information of the serving cell, for example, if a serving cell is activated but there is no previous activation information, the first network device needs to obtain the activation information; or if a serving cell is deactivated but the serving cell was previously active and the first network device had previously obtained the activation information, the first network device needs to obtain the deactivation information.

The adding information and the release information of the serving cell may be similar to the activation information and the deactivation information.

In an embodiment of this application, the positioning procedure includes but is not limited to at least one of the following: an indication for PRS assistance data, an indication for a PRS configuration, sending an MG request to the second network device, sending a PRS processing window indication to the UE, sending a PRS processing window indication to the second network device, sending a PRS processing window request to the second network device, an indication for behavior of the terminal (for example, behavior of measuring the PRS by the terminal), a request for a positioning measurement result, an indication for behavior of the second network device, and an indication of whether MG measurement is necessarily required for the PRS of a positioning frequency layer.

In an embodiment of this application, before the network device obtains the target information, the method further includes:
sending first request information, where the first request information is used to request the related information of the serving cell of the terminal, and the first request information includes at least one of the following:
a request identifier associated with a target parameter in the related information; and
target frequency domain location information, where the target frequency domain location information is used to request related information of a serving cell corresponding to a target frequency domain location.

For example, the identifier of the target parameter is used to request information about the serving cell under the corresponding identifier, where the information may include at least one of: the timing information, the frequency domain location information, the identity information, the activation information, the deactivation information, the adding information, and the release information of the serving cell. For example, by means of the enumeration type {the timing information, the frequency domain location information, the identity information, the activation information, the deactivation information, the adding information, and the release information of the serving cell . . . }, the corresponding serving cell information is requested.

The target frequency domain location information includes at least one of the following:
a frequency, for example, an ARFCN
a frequency domain range;
an identifier of a positioning frequency layer;
a point A of the positioning frequency layer;
an SCS of the positioning frequency layer; and
a band indicator.

In some embodiments, the target frequency domain location information is related to a frequency domain location of the PRS, for example, frequency domain location information of the positioning frequency layer of the PRS. In some embodiments, in addition to the serving cell corresponding to the target frequency domain location, the first network device may further request information about (all or some of) activated serving cells, and/or (all or some of) serving cells that have been added.

In some embodiments, the network requests information about a serving cell corresponding to a frequency 1, and a network request may include at least one of: an ARFCN of the frequency 1, a band indicator of the frequency 1, and a positioning frequency layer identifier corresponding to the frequency 1. In this case, the second network device or the terminal may feed back related information of the serving cell corresponding to the frequency 1.

In an embodiment of this application, when a receive timing difference between a serving cell corresponding to a PRS frequency and a non-serving cell corresponding to a PRS to be measured by the UE does not meet the target timing difference threshold, the first network device may send, based on a UE capability (for example, the UE supports processing the PRS by using FFT), target indication information for indicating that the terminal performs PRS measurement by using only the MG, or, send target indication information for indicating that the terminal performs PRS measurement by using an active BWP, or send target indication information for indicating that the terminal may perform PRS measurement by using the active BWP or the MG, or send target indication information for indicating that the terminal is not limited to performing PRS measurement by using the MG.

In an embodiment of this application, the PRS measurement manner indicated by the target indication information includes: The terminal performs PRS measurement on a first target PRS by using an MG. The target indication information may be sent in a case that a non-serving cell corresponding to the first target PRS does not meet a PRS measurement condition.

After obtaining the target information, the first network device may send, to the base station and/or the terminal, indication information (that is, the target indication information) related to the MG configuration, where the indication information is used to indicate to the terminal that, for the first target PRS, the terminal can only use the MG for measurement, or, for the first target PRS, the base station can only configure the MG for the terminal to measure the PRS. In other words, for the first target PRS, the UE cannot measure the PRS in the MG-less manner, and is not allowed to measure the PRS by using the active DL BWP; or, the second network device can only configure the MG, and cannot configure a PRS processing window.

In some embodiments, the first target PRS includes a PRS that is in a non-serving cell of the terminal and that does not meet a PRS measurement condition. In some embodiments, the first target PRS further includes at least one of the following: a PRS of at least one non-serving cell; a PRS of at least one TRP; and a PRS of at least one positioning frequency layer.

In some embodiments, (under a particular positioning frequency layer), the target indication information is sent if a quantity of non-serving cells (or TRPs) that do not meet the PRS measurement condition exceeds N; or (under a particular positioning frequency layer), the target indication information is sent if a quantity of non-serving cells (or TRPs) that meet the PRS measurement condition does not exceed M. N and M may be obtained in at least one of the manners: network indication, protocol agreement, and terminal indication. The first target PRS may be a PRS of at least one positioning frequency layer, or a PRS under at least one TRP.

When the first network device does not send the target indication information, for the first target PRS, the terminal may measure the PRS by using the MG or the active BWP; or, the base station may configure the MG for the terminal, or may not configure the MG and allow the UE to measure the PRS by using the active BWP.

The target indication information is used to indicate the following: In a case that the terminal performs PRS measurement on the first target PRS by using the MG, the target indication information includes at least one of the following:
an MG enable identifier, where for example, if the MG enable identifier is 1, for the first target PRS, the terminal can only use the MG; or when the identifier is 0 or a default indication, there is no limitation (both the MG and the MG-less manners may be used); and the MG enable identifier may be an indication of each positioning frequency layer; and
positioning frequency layer information of the first target PRS, namely, frequency domain information corresponding to the first target PRS, where the information includes: at least one of: the positioning frequency layer identifier (where the identifier indicates validity for the positioning frequency layer) and the frequency domain information of the positioning frequency layer (for example, at least one of: the Point A, the center frequency, the bandwidth, the SCS, the start frequency domain location, and the frequency domain range).

The target indication information may be included in the MG request and/or the PRS processing window request initiated by the first network device, or included in an LTE Positioning Protocol (LPP) message (for example, a location information request message) sent by the first network device to the terminal. In some embodiments, the first network device may perform implicit indication based on whether the MG request and/or the PRS processing window request include/includes frequency domain location information of the PRS. For example, if the MG request and/or the PRS processing window request do/does not include the frequency domain location information of the positioning frequency layer, the terminal can measure the PRS of the positioning frequency layer only by using the MG (or, the base station can only configure the MG to measure the corresponding PRS). The frequency domain location information includes at least one of the following: the SCS, the point-A, the bandwidth, the start frequency domain location, the frequency domain range, the center frequency, and the like.

In an embodiment of this application, the PRS measurement manner indicated by the target indication information includes: In a case that the terminal performs PRS measurement by using the active BWP, ignoring measurement on a second target PRS and/or measurement on a third target PRS. In other words, the location server indicates to the second network device or the terminal that: In a case that the terminal performs PRS measurement by using the active BWP, measurement of the second target PRS and/or measurement of the third target PRS are/is ignored. For example, the target indication information is used to indicate that: When the UE measures the PRS by using the BWP, measurement of the second target PRS is ignored; and/or, is used to indicate the PRS (namely, the third target PRS) that should be measured when the UE measures the PRS by using the BWP. The target indication information may be included in a PRS processing window configuration indication. In some embodiments, the PRS processing window configuration (or, the PRS configuration when the UE measures the PRS by using the BWP) indicates that the UE ignores measurement of the second target PRS (explicit indication); or the PRS processing window configuration indication does not include a configuration of the second target PRS (implicit indication), that is, the PRS processing window configuration is not related to the second target PRS. In some embodiments, the PRS processing window configuration indicates measurement of the third target PRS (explicit indication) by the UE; or the configuration of the PRS processing window includes only the third target PRS (implicit indication).

In some embodiments, after obtaining the target indication information, the second network device sends the configuration of the PRS processing window to the terminal. The PRS processing window configuration (or, the PRS configuration when the UE measures the PRS by using the BWP) indicates that the UE ignores measurement of the second target PRS (explicit indication); or the PRS processing window configuration does not include the configuration of the second target PRS (implicit indication), that is, the PRS processing window configuration is not related to the second target PRS. In some embodiments, the PRS processing window configuration indicates measurement of the third target PRS (explicit indication) by the UE; or the configuration of the PRS processing window includes only the configuration of the third target PRS (implicit indication).

The second target PRS includes a PRS that is in a non-serving cell and that does not meet a PRS measurement condition, and/or, the third target PRS includes a PRS that is in a non-serving cell and that meets the PRS measurement condition.

The second target PRS includes at least one of the following:
a PRS of at least one non-serving cell;
a PRS of at least one transmitting receiving point TRP; and
a PRS of at least one positioning frequency layer; and and/or,
the third target PRS includes at least one of the following:
a PRS of at least one non-serving cell;
a PRS of at least one TRP;
a PRS of at least one positioning frequency layer.

The second target PRS includes at least one of the following:
a positioning frequency layer identifier corresponding to the second target PRS;
a TRP identifier corresponding to the second target PRS;
a PRS resource set identifier corresponding to the second target PRS;
an identifier of the second target PRS; and
an identifier of a cell that sends the second target PRS;
and/or,
the third target PRS includes at least one of the following:
a positioning frequency layer identifier corresponding to the third target PRS;
a TRP identifier corresponding to the third target PRS;
a PRS resource set identifier corresponding to the third target PRS;
an identifier of the third target PRS; and
an identifier of a cell that sends the third target PRS.

In some embodiments, the third target PRS may be included in the PRS configuration, and the PRS configuration is related to measurement by the UE by using the BWP, or the PRS configuration is related to the PRS processing window, or the PRS configuration is the PRS configuration when the UE measures the PRS by using the active BWP or the PRS processing window. For example, the third target PRS configuration carries an identifier for identifying that the PRS configuration is dedicated to measurement of the PRS by using the BWP.

In some embodiments, the third target PRS configuration is different from the PRS configuration when the UE uses the MG, and is only used in the case of measurement by using the BWP.

In an embodiment of this application, the target indication information is further used to indicate a PRS processing window configuration, and the PRS processing window configuration does not include a configuration of a fourth target PRS, or the PRS processing window configuration is not related to the fourth target PRS. The fourth target PRS includes at least one of the following:
a PRS of at least one non-serving cell;
a PRS of at least one TRP;
a PRS of at least one positioning frequency layer; and
a PRS that is in a non-serving cell and that does not meet a PRS measurement condition.

In an embodiment of this application, the target indication information is further used to indicate at least one of: whether the terminal can request an MG, whether the terminal can request a PRS processing window, whether the second network device has requested the MG, whether the second network device has requested the PRS processing window, a manner in which the terminal requests the MG, and a manner in which the terminal requests the PRS processing window. The manner of requesting the MG or the manner of requesting the PRS processing window is, for example, implemented by using a Media Access Control (MAC) Control Element (CE) request, a Radio Resource Control (RRC) request, or an Uplink Control Information (UCI) request.

In some embodiments, the target indication information may be included in the location information request (for example, the LPP message RequestLocationInformation) sent by the first network device, or assistance data (for example, an LPP message ProvideAssistanceData), or a separate message.

In some embodiments, whether the terminal has requested the MG and/or the PRS processing window means whether the first network device requests the MG and/or the PRS processing window from the second network device by using the NR Positioning Protocol A (NRPPa).

In some embodiments, whether the terminal can request the MG and/or the PRS processing window means whether the second network device allows the terminal to request the MG and/or the PRS processing window from the second network device by using signaling.

In some embodiments, if the terminal receives the target indication message, or the location information request, or a message received later in the two, the terminal starts a timer, and receives the MG configuration (or activation) or PRS processing window configuration (or activation) message in the timer; and after the timer ends (or is released, or is stopped), if the terminal does not receive the MG configuration (or activation) or PRS processing window configuration (or activation) message, the UE initiates a request for the MG or PRS processing window configuration (or activation) to the second network device (or the first network device) and/or reports information that the MG or PRS processing window configuration is invalid.

In some embodiments, if the terminal receives the target indication message, or the location information request, or a message received later in the two, the terminal starts a timer, and receives the MG configuration (or activation) message in the timer; and after the timer ends (or is released, or is stopped), if the terminal does not receive the MG configuration (or activation) message, the UE initiates a request for the MG configuration (or activation) to the second network device (or the first network device) and/or reports information that the MG configuration is invalid. In some embodiments, the timer is only used in the case that the terminal measures the PRS by using the MG, and if the terminal determines or receives an indication confirming that the target PRS can be measured by using the active BWP, the terminal ignores the timer.

In some embodiments, a start time of the timer is a time at which the terminal receives the target indication information or the location information request, or the message received later in the two; and a length (or an end time) of the timer may be determined in at least one of the manners: network device (the first network device or the second network device) indication, protocol agreement, and terminal selection.

In another embodiment of this application, the target indication information is used to indicate (for example, indication from the first network device to the second network device) requirement information for a positioning service of the terminal, where the target indication information includes at least one of: a Quality of Service (QOS) requirement, and a terminal measurement performance requirement. The QoS requirement includes at least one of a positioning accuracy requirement and a positioning delay requirement. In some embodiments, the terminal measurement performance requirement information is a measurement performance requirement corresponding to a current terminal measurement quantity (for example, a Reference Signal Time Difference (RSTD), a Reference Signal Received Power (RSRP), or a Receive-Transmit (Rx-Tx) time difference), and indicates that the measurement quantity reported by the terminal should meet a requirement, including at least one of: an accuracy measurement performance requirement, and a time delay measurement performance requirement. For example, the accuracy measurement performance requirement is indicated, and a requirement table corresponding to accuracy and PRS bandwidth, a signal-to-noise ratio, a subcarrier spacing, a channel type, and the like is indicated.

In the foregoing description, the capability information of the terminal includes at least one of the following:
whether processing a PRS on an active Downlink (DL) BWP (or in a PRS processing window) is supported;
whether processing the PRS by using an MG is supported;
a processing capability of processing the PRS by using the MG;
a processing capability of processing the PRS by using the active DL BWP (or in the PRS processing window);
whether sliding-related processing and/or FFT processing of the PRS are/is supported under a condition of processing the PRS by using the active DL BWP and/or a condition of processing the PRS by using the MG;
whether processing a PRS of a non-synchronous neighboring cell is supported under a condition of processing the PRS by using the active DL BWP and/or a condition of processing the PRS by using the MG;
whether processing a PRS of a non-serving cell in a manner of ignoring a timing difference threshold is supported under a condition of processing the PRS by using the active DL BWP and/or a condition of processing the PRS by using the MG; and
a threshold range of receive timing difference between a non-serving cell and a serving cell for supporting PRS processing under a condition of processing the PRS by using the active DL BWP and/or a condition of processing the PRS by using the MG.

This means whether processing the PRS of the non-serving cell that exceeds the timing difference threshold is supported under the condition of processing the PRS by using the active DL BWP and/or the condition of processing the PRS by using the MG. In some embodiments, the timing difference threshold is determined in at least one of the manners: network indication, protocol agreement, and terminal selection. For example, the timing difference threshold is a length of a Cyclic Prefix (CP).

In some embodiments, the terminal capability type may be per UE or per band.

The UE may report the capability information to the first network device and/or the second network device. The capability information of the terminal may be reported separately or may be included in a related capability of measuring the PRS by using the active BWP (or by using the PRS processing window).

Herein, sliding-related processing may also be understood as: time domain related processing, or time domain processing. FFT processing may also be understood as DFT processing, or frequency domain sampling processing, or frequency domain processing.

In some embodiments, the receive timing difference between the non-serving cell of the terminal and the serving cell of the terminal may be understood as:
a timing difference between timing of the non-serving cell of the terminal and timing of the serving cell of the terminal; or, a receive timing difference between receive timing of the non-serving cell of the terminal and receive timing of the serving cell of the terminal; or, a receive timing difference between a PRS of the non-serving cell of the terminal and a PRS of the serving cell; or a receive timing difference between the PRS of the non-serving cell of the terminal and the PRS of the serving cell.

The capability information of the terminal may be sent by the UE directly to the second network device, or may be sent by the UE to the first network device and then sent by the first network device to the second network device.

If the UE capability supports sliding-related processing of the PRS or processing of the PRS of the non-synchronous neighboring cell, or the receive (Rx) timing difference between the non-serving cell and the serving cell for processing is relatively large, it may be considered that the UE can ignore the PRS measurement condition to process the PRS of the non-serving cell.

In some embodiments, the PRS measurement manner indicated by the target indication information includes:
performing PRS measurement by using an active BWP in a case that at least one of the following is met:
all non-serving cells to be measured meet a PRS measurement condition;
the all non-serving cells to be measured are synchronous with a serving cell; and
in a case that the terminal supports a sliding window, ignoring whether the all non-serving cells to be measured meet the PRS measurement condition, or ignoring whether the all non-serving cells to be measured are synchronous with the serving cell.

For example, the target indication information is used to indicate the following: The terminal performs PRS measurement by using an active BWP on at least one of the following assumptions:
all non-serving cells to be measured meet a PRS measurement condition;
the all non-serving cells to be measured are synchronous with a serving cell; and
in a case that the terminal supports a sliding window, ignoring whether the all non-serving cells to be measured meet the PRS measurement condition, or ignoring whether the all non-serving cells to be measured are synchronous with the serving cell.

In other words, in the solution in which the first network device determines, according to the target information, whether the non-serving cell of the terminal meets the PRS measurement condition of the terminal, the assumption of the UE when the terminal measures the PRS by using the active BWP includes at least one of the following:

When the UE measures the PRS by using the active DL BWP, the UE assumes that all neighboring cell TRPs to be measured meet a conditional threshold;
when the UE measures the PRS by using the active DL BWP, the UE assumes that all neighboring cell TRPs to be measured are synchronous with the serving cell; and
if the UE can support a sliding window, when the UE measures the PRS by using the active DL BWP, the UE ignores whether all the neighboring cell TRPs to be measured meet the conditional threshold or ignores whether all the neighboring cell TRPs to be measured are synchronous with the serving cell.

In some alternative embodiments, when the terminal measures the PRS by using the active BWP, assumption of the UE includes at least one of the following:

When the UE measures the PRS by using the active DL BWP, the UE assumes that all neighboring cell TRPs to be measured meet a conditional threshold;
when the UE measures the PRS by using the active DL BWP, the UE assumes that all neighboring cell TRPs to be measured are synchronous with the serving cell; and
if the UE can support a sliding window, when the UE measures the PRS by using the active DL BWP, the UE ignores whether all the neighboring cell TRPs to be measured meet the conditional threshold or ignores whether all the neighboring cell TRPs to be measured are synchronous with the serving cell.

An embodiment of this application further provides a method for reporting uplink timing adjustment, where the method includes:

A terminal sends uplink timing adjustment information to a network device, where the uplink timing adjustment information is used to reduce an error caused by the uplink timing adjustment.

For example, the network device may include a first network device and a second network device, where the first network device may be a location server, and the second network device may be a serving base station. In an uplink positioning method, and/or, in an uplink positioning and downlink positioning method, the terminal may report the uplink timing adjustment information to the first network device (for example, the location server) and/or the second network device (for example, the serving base station), to reduce an error caused by the uplink timing adjustment.

The terminal may directly report the uplink timing adjustment information to the location server by using an LPP message, or indirectly report the uplink timing adjustment information to the location server through forwarding by using a serving gNB, that is, the terminal first sends the uplink timing adjustment information to the serving gNB, and then the serving gNB sends the uplink timing adjustment information to the location server by using an NRPPa message.

In some embodiments, the uplink timing adjustment information includes: change information of SRS uplink timing in a Sounding Reference Signal (SRS) transmission process, or change information of uplink timing during uplink timing adjustment each time.

For the change of SRS uplink timing in the SRS transmission process, for example, if uplink timing is adjusted for a plurality of times between an SRS instance 1 and an SRS instance 2, the terminal reports a total change in the uplink timing corresponding to the SRS instance 2 and the SRS instance 1, rather than a time of each uplink timing adjustment between the SRS instance 1 and the SRS instance 2.

For the change of uplink timing during uplink timing adjustment each time, for example, if uplink timing is adjusted for a plurality of times between the SRS instance 1 and the SRS instance 2, the terminal reports the time of uplink timing adjustment each time rather than the total change of the uplink timing corresponding to the SRS instance 2 and the SRS instance 1 (or, not related to the SRS uplink timing change).

In some embodiments, a type of the uplink timing adjustment information includes at least one of the following:
automatic uplink timing adjustment by the terminal;
timing advance adjustment; and
a sum of the automatic uplink timing adjustment by the terminal and the timing advance adjustment.

The sum of the automatic uplink timing adjustment by the terminal and the timing advance adjustment herein may also be understood as a total uplink timing adjustment including the automatic uplink timing adjustment by the terminal and the timing advance adjustment.

In some embodiments, the uplink timing adjustment information includes a time stamp corresponding to the uplink timing adjustment, where the time stamp is used to indicate a time at which the uplink timing adjustment occurs.

In an implementation, the uplink timing adjustment information is a change in the SRS uplink timing in the SRS transmission process, and the time stamp is a time stamp corresponding to the SRS, or the time stamp is a time at which the most recent uplink timing adjustment previous to the SRS occurs. Herein, each time stamp corresponds to one value of uplink timing adjustment.

In an implementation, the uplink timing adjustment information is a change in the SRS uplink timing in the SRS transmission process, and the time stamp includes a time stamp corresponding to the SRS and a time at which the most recent uplink timing adjustment previous to the SRS occurs. Herein, two time stamps correspond to one value of uplink timing adjustment.

In an implementation, the uplink timing adjustment information is a change in uplink timing during uplink timing adjustment each time, and the time stamp is a time stamp corresponding to uplink timing adjustment each time. Herein, each time stamp corresponds to one value of uplink timing adjustment.

In an implementation, the uplink timing adjustment information is a change in SRS uplink timing in the SRS transmission process, and the terminal reports two time stamps.

The first time stamp is a time stamp corresponding to the SRS, or the time stamp is a time at which the most recent uplink timing adjustment previous to the SRS occurs. Each time stamp corresponds to one value of uplink timing adjustment.

The second time stamp is a time stamp corresponding to uplink timing adjustment each time. This time stamp is only used to indicate a time at which uplink timing adjustment on the location server occurs. Each time stamp is not associated with a value of uplink timing adjustment.

In an implementation, the uplink timing adjustment information is a change in SRS uplink timing in the SRS transmission process, and the terminal reports two time stamps.

The first time stamp is a time stamp corresponding to the SRS, or the time stamp is a time at which the most recent uplink timing adjustment previous to the SRS occurs. Each time stamp corresponds to one value of uplink timing adjustment.

The second time stamp is a time stamp corresponding to the most recent uplink timing adjustment before the PRS is received. This time stamp is not associated with a value of uplink timing adjustment.

In an implementation, the uplink timing adjustment information is a change in SRS uplink timing in the SRS transmission process, and the terminal reports three time stamps.

The first time stamp is a time stamp corresponding to the SRS. Each time stamp corresponds to one value of uplink timing adjustment.

The second time stamp is a time stamp corresponding to the most recent uplink timing adjustment before the PRS is received. This time stamp is not associated with a value of uplink timing adjustment.

The third time stamp is a time at which the most recent uplink timing adjustment previous to the SRS occurs. This time stamp is not associated with a value of uplink timing adjustment.

In some embodiments, in a case that there are a plurality of types of the uplink timing adjustment information, different types of the uplink timing adjustment information are reported separately. Different types of uplink timing adjustment information correspond to respective time stamps.

In an implementation, the terminal reports the uplink timing adjustment information by using different reports. Different reports are associated with uplink timing adjustment information of different types.

In an implementation, the terminal reports uplink timing adjustment information in a same report, but distinguishes between different types of uplink timing adjustment information by using different fields.

For example, a field A indicates automatic uplink timing adjustment by the terminal; and a field B indicates timing advance adjustment.

In some embodiments, when the terminal reports a particular uplink timing adjustment, if only one type of uplink timing adjustment is included, the other type of uplink timing adjustment may be defaulted, or indicated as 0.

The terminal receives a request from the location server before reporting the uplink timing adjustment information, where the request is used to request the terminal to report the uplink timing adjustment information. The request information includes at least one of the following information:

A type of reporting the uplink timing adjustment information includes one of: periodic reporting and event-triggered reporting.

Further, the request information includes period information of periodic reporting or event information of event-triggered reporting.

Further, the event information is: The terminal reports when the SRS uplink timing in the SRS transmission process changes or during uplink timing adjustment each time.

A type of the uplink timing adjustment information is at least one of: automatic uplink timing adjustment by the terminal, timing advance adjustment, and the sum of automatic uplink timing adjustment by the terminal and timing advance adjustment.

A reference object of the uplink timing adjustment information is one of: the change in the SRS uplink timing in the SRS transmission process, and the change in the uplink timing during uplink timing adjustment each time.

In some embodiments, the uplink timing adjustment information is uplink timing adjustment information in a Measurement Time Window (MTW) of the terminal.

In some embodiments, for periodic reporting, a configuration related to ‘periodic reporting’ includes at least one of: a period size (or a time gap between two successive reports), a quantity of periods (or, a total quantity of periodic reports), a start time of the periodic reports, and a period offset of the periodic reports. The configuration may be determined in at least one of the manners: network indication, protocol agreement, and terminal selection.

In an implementation of periodic reporting, if the uplink timing adjustment information is the change information of uplink timing during uplink timing adjustment each time, each periodic report includes all uplink timing adjustment information and a corresponding time stamp in duration of the period.

In another implementation of periodic reporting, if the uplink timing adjustment information is the change information of SRS uplink timing, each periodic report includes all uplink timing adjustment information of the SRS and a corresponding time stamp in duration of the period.

In some embodiments, for event-triggered reporting, the configuration related to ‘event-triggered reporting’ includes at least one of: event information, an event timer, duration of an event report, a minimum gap between successive event reports, a maximum gap between successive event reports, a maximum quantity of event reports, and the like. The configuration may be determined in at least one of the manners: network indication, protocol agreement, and terminal selection. Herein, the event timer is set as follows: After an event occurs, reporting is performed no later than one time gap.

In an implementation of event-triggered reporting, if the event information is the change in uplink timing during uplink timing adjustment each time, each event report includes corresponding uplink timing adjustment information and a corresponding time stamp.

In another implementation of event-triggered reporting, if the event information is the change in SRS uplink timing, uplink timing adjustment information to be reported is: the change in uplink timing adjustment each time. In this case, each event report includes change information of all uplink timing adjustments between two event reports and a corresponding time stamp (for example, a time stamp of the change in the SRS uplink timing and/or a time stamp of the change in the uplink timing adjustment each time).

In another implementation of event-triggered reporting, if the event information is the change in SRS uplink timing, uplink timing adjustment information to be reported is: the change in SRS uplink timing. In this case, each event report includes corresponding SRS timing adjustment information and a corresponding time stamp.

In some embodiments, the SRS herein may be understood as an SRS instance, an SRS time occasion, an SRS period, an SRS resource, and an SRS resource set.

In some embodiments, the SRS includes but is not limited to at least one of: an SRS used for positioning and a conventional SRS (an SRS used for MIMO).

In some embodiments, the terminal reports capability information to at least one of: the first network device and the second network device, where the capability information includes at least one of the following:
whether reporting the uplink timing adjustment is supported;
which reporting manner is supported, for example, at least one periodic reporting and event-triggered reporting;
a type of the uplink timing adjustment information, for example, at least one of: automatic uplink timing adjustment by the terminal, timing advance adjustment, and the sum of automatic uplink timing adjustment by the terminal and timing advance adjustment; and
a reference object of the uplink timing adjustment information, for example, one of: the change in the SRS uplink timing in the SRS transmission process, and the change in the uplink timing during uplink timing adjustment each time.

An embodiment of this application further provides a method for reporting uplink timing adjustment, where the method includes:

A second network device sends uplink timing adjustment information to a first network device, where the uplink timing adjustment information is used to reduce an error caused by the uplink timing adjustment.

For example, in an uplink positioning method, and/or, in an uplink positioning and downlink positioning method, the second network device (for example, the serving base station) reports the uplink timing adjustment information of the terminal to the location server, to reduce an error caused by the uplink timing adjustment.

In some embodiments, a type of the uplink timing adjustment information reported by the serving base station is timing advance adjustment.

In some embodiments, a type of the uplink timing adjustment information includes at least one of the following:
automatic uplink timing adjustment by a terminal;
timing advance adjustment; and
a sum of the automatic uplink timing adjustment by the terminal and the timing advance adjustment.

For example, automatic uplink timing adjustment by the terminal may be reported by the terminal; timing advance adjustment may be determined by the serving base station or reported by the terminal; and the sum of the automatic uplink timing adjustment by the terminal and the timing advance adjustment may be reported by the terminal, or may be finally determined by the serving base station based on the automatic uplink timing adjustment reported by the terminal and timing advance adjustment determined by the serving base station.

In some embodiments, the uplink timing adjustment information includes: change information of SRS uplink timing in an SRS transmission process, or change information of uplink timing during uplink timing adjustment each time.

In some embodiments, the uplink timing adjustment information includes a time stamp corresponding to the uplink timing adjustment, and the time stamp is used to indicate a time at which the uplink timing adjustment occurs.

In some embodiments, in a case that there are a plurality of types of the uplink timing adjustment information, different types of the uplink timing adjustment information are reported separately.

The serving base station receives a request from the location server before reporting the uplink timing adjustment information, where the request is used to request the serving base station to report the uplink timing adjustment information of the terminal. The request information includes at least one of the following information:

A type of reporting the uplink timing adjustment information includes one of: periodic reporting and event-triggered reporting.

A type of the uplink timing adjustment information is at least one of: automatic uplink timing adjustment by the terminal, timing advance adjustment, and the sum of automatic uplink timing adjustment by the terminal and timing advance adjustment.

A reference object of the uplink timing adjustment information is one of: the change in the SRS uplink timing in the SRS transmission process, and the change in the uplink timing during uplink timing adjustment each time.

In some embodiments, for the method for information reporting of the uplink timing adjustment information including periodic reporting and event reporting by the second network device (for example, the serving base station), reference may be made to the method for periodic reporting and event reporting on the terminal side. Details are not described herein again.

An implementation of reporting the uplink timing adjustment by the serving base station is as follows: The serving base station reports the uplink timing adjustment based on event information (the change in the timing advance adjustment), and each report includes information about timing advance adjustment at the present time. The timing advance adjustment is reported no later than a time at which the serving base station sends a Timing Advance (TA) command to the terminal plus a time gap time gap. The time gap is determined in at least one of the manners: protocol agreement, network indication, and terminal selection.

An embodiment of this application further provides a method for reporting uplink timing adjustment, where the method includes:

A first network device receives uplink timing adjustment information sent by a terminal or a second network device, where the uplink timing adjustment information is used to reduce an error caused by the uplink timing adjustment during location calculation.

In some embodiments, the method further includes: The first network device sends the uplink timing adjustment information to a non-serving base station participating in positioning, for the second network device to consider, during execution of positioning measurement, impact brought by the uplink timing adjustment information.

It should be noted that the positioning method provided in the embodiments of this application may be performed by a positioning apparatus, or a control module that is in the positioning apparatus and that is configured to perform the positioning method.

In the following embodiment, an example in which the positioning apparatus performs the positioning method is used to describe the positioning apparatus provided in the embodiments of this application.

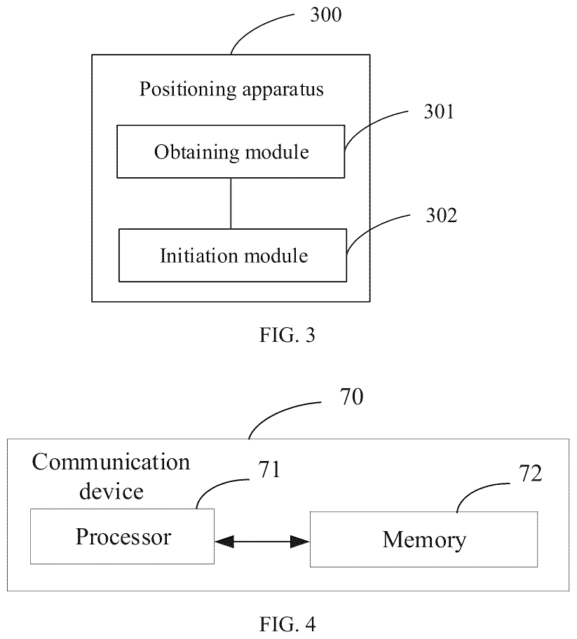

With reference to FIG. 3, FIG. 3 is a structural diagram of a positioning apparatus according to an embodiment of this application. The positioning apparatus 300 includes:
an obtaining module 301, configured to obtain target information; and
an initiation module 302, configured to initiate a positioning procedure according to the target information.

The positioning procedure includes at least one of the following:
sending target indication information to a second network device and/or a terminal, where the target indication information is used to indicate a positioning reference signal PRS measurement manner of the terminal;
sending PRS positioning assistance data to the terminal;
sending a location information request to the terminal, where the location information request is used to request a PRS measurement result of the terminal; and
performing location calculation, where the location calculation is used to calculate a location of the terminal.

In some embodiments, the target information includes at least one of the following:
related information of a serving cell;
capability information of the terminal; and
timing difference threshold information.

In some embodiments, the related information of the serving cell includes at least one of the following:
synchronization information of the serving cell;
timing information of the serving cell;
frequency domain location information of the serving cell;
identity information of the serving cell;
activation information of the serving cell;
deactivation information of the serving cell;
adding information of the serving cell; and
release information of the serving cell.

In some embodiments, the serving cell includes at least one of: a primary cell, a primary secondary cell, and a secondary cell.

In some embodiments, the timing information of the serving cell includes at least one of the following:
a timing difference between the serving cell and the primary cell;
an offset between a system frame 0 of the serving cell and a system frame 0 of the primary cell; and
an absolute time of the system frame 0 of the serving cell.

In some embodiments, the frequency domain location information of the serving cell includes at least one of the following:
a frequency location of the serving cell;
a center frequency location of the serving cell;
a carrier bandwidth of the serving cell;
a reference point of the serving cell;
a subcarrier spacing SCS supported by the serving cell;
a carrier range of the serving cell; and
a band indicator corresponding to the serving cell.

In some embodiments, the identity information of the serving cell includes at least one of the following:
a serving cell identity corresponding to the serving cell;
a new radio cell global identifier NCGI corresponding to the serving cell;
a physical cell identifier PCI corresponding to the serving cell; and
a band indicator corresponding to the serving cell.

In some embodiments, the apparatus further includes:
a sending module, configured to send first request information, where the first request information is used to obtain the related information of the serving cell of the terminal.

In some embodiments, the first request information includes at least one of the following:
a request identifier associated with a target parameter in the related information; and
target frequency domain location information, where the target frequency domain location information is used to request related information of a serving cell corresponding to a target frequency domain location.

In some embodiments, the target indication information is used to indicate the following: The terminal performs PRS measurement on a first target PRS by using an MG.

In some embodiments, the first target PRS includes a PRS that is in a non-serving cell of the terminal and that does not meet a PRS measurement condition.

In some embodiments, the first target PRS includes at least one of the following:
a PRS of at least one non-serving cell;
a PRS of at least one transmitting receiving point TRP; and
a PRS of at least one positioning frequency layer.

In some embodiments, the target indication information is used to indicate the following: In a case that the terminal performs PRS measurement on the first target PRS by using the MG, the target indication information includes at least one of the following:
an MG enable identifier; and
positioning frequency layer information of the first target PRS.

In some embodiments, the target indication information is used to indicate the following: In a case that the terminal performs PRS measurement by using an active BWP, measurement on a second target PRS and/or measurement on a third target PRS are/is ignored.

In some embodiments, the second target PRS includes at least one of the following:
a PRS of at least one non-serving cell;
a PRS of at least one transmitting receiving point TRP; and
a PRS of at least one positioning frequency layer; and
and/or,
the third target PRS includes at least one of the following:
a PRS of at least one non-serving cell;
a PRS of at least one TRP;
a PRS of at least one positioning frequency layer.

In some embodiments, the second target PRS includes a PRS that is in a non-serving cell and that does not meet a PRS measurement condition, and/or, the third target PRS includes a PRS that is in a non-serving cell and that meets the PRS measurement condition.

In some embodiments, the second target PRS includes at least one of the following:
a positioning frequency layer identifier corresponding to the second target PRS;
a TRP identifier corresponding to the second target PRS;
a PRS resource set identifier corresponding to the second target PRS;
an identifier of the second target PRS; and
an identifier of a cell that sends the second target PRS;
and/or,
the third target PRS includes at least one of the following:
a positioning frequency layer identifier corresponding to the third target PRS;
a TRP identifier corresponding to the third target PRS;
a PRS resource set identifier corresponding to the third target PRS;
an identifier of the third target PRS; and
an identifier of a cell that sends the third target PRS.

In some embodiments, the target indication information is used to indicate the following: The terminal performs PRS measurement by using an active BWP on at least one of the following assumptions:
all non-serving cells to be measured meet a PRS measurement condition;
the all non-serving cells to be measured are synchronous with a serving cell; and
in a case that the terminal supports a sliding window, ignoring whether the all non-serving cells to be measured meet the PRS measurement condition, or ignoring whether the all non-serving cells to be measured are synchronous with the serving cell.

In some embodiments, the target indication information is used to indicate a PRS processing window configuration, and the PRS processing window configuration does not include a configuration of a fourth target PRS, or the PRS processing window configuration is not related to the fourth target PRS.

In some embodiments, the fourth target PRS includes at least one of the following:
a PRS of at least one non-serving cell;
a PRS of at least one TRP;
a PRS of at least one positioning frequency layer; and
a PRS that is in a non-serving cell and that does not meet a PRS measurement condition.

In some embodiments, the target indication information is used to indicate at least one of: whether the terminal can request an MG, whether the terminal can request a PRS processing window, whether the second network device has requested the MG, whether the second network device has requested the PRS processing window, a manner in which the terminal requests the MG, and a manner in which the terminal requests the PRS processing window.

In some embodiments, the capability information of the terminal includes at least one of the following:
whether processing a PRS on an active downlink DL BWP is supported;
whether processing the PRS by using an MG is supported;
a processing capability of processing the PRS by using the MG;
a processing capability of processing the PRS by using the active DL BWP;
whether sliding-related processing and/or FFT processing of the PRS are/is supported;
whether processing a PRS of a non-synchronous neighboring cell is supported;
whether processing a PRS of a non-serving cell in a manner of ignoring a timing difference threshold is supported; and
a threshold range of receive timing difference between a non-serving cell and a serving cell for supporting PRS processing.

In some embodiments, the PRS measurement condition includes that a receive timing difference between the non-serving cell of the terminal and the serving cell of the terminal is less than or equal to a target timing difference threshold.

The positioning apparatus 300 provided in this embodiment of this application can implement the processes implemented in the method embodiment of FIG. 2 and achieve the same technical effect. To avoid repetition, details are not described herein again.

For example, as shown in FIG. 4, an embodiment of this application further provides a communication device 70, including a processor 71, a memory 72, and a program or an instruction that is stored in the memory 72 and that can be run on the processor 71. When the communication device 70 is a network side device, the program or the instruction is executed by the processor 71 to implement the processes of the embodiment of the positioning method of FIG. 2 or the embodiments of the method for reporting uplink timing adjustment, and the same technical effect can be achieved. The communication device 70 may be a terminal, or may be a network side device.

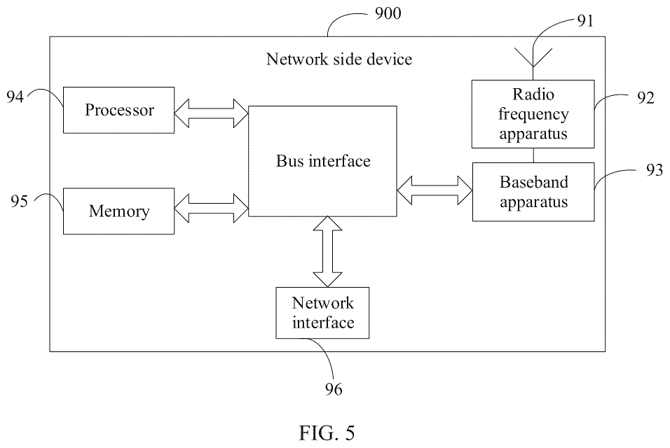

For example, an embodiment of this application further provides a network side device. As shown in FIG. 5, the network side device 900 includes: an antenna 91, a radio frequency apparatus 92, and a baseband apparatus 93. The antenna 91 is connected to the radio frequency apparatus 92. In an uplink direction, the radio frequency apparatus 92 receives information by using the antenna 91, and sends the received information to the baseband apparatus 93 for processing. In a downlink direction, the baseband apparatus 93 processes information that needs to be sent, and sends processed information to the radio frequency apparatus 92. The radio frequency apparatus 92 processes the received information, and sends processed information by using the antenna 91.

The frequency band processing apparatus may be located in the baseband apparatus 93. The method performed by the network side device in the foregoing embodiment may be implemented in the baseband apparatus 93. The baseband apparatus 93 includes a processor 94 and a memory 95.

The baseband apparatus 93 may include, for example, at least one baseband board, and a plurality of chips are disposed on the baseband board. As shown in FIG. 5, one chip is, for example, the processor 94, and is connected to the memory 95, to invoke a program in the memory 95 to perform operations of a network device shown in the foregoing method embodiment.

The baseband apparatus 93 may further include a network interface 96, configured to exchange information with the radio frequency apparatus 92. For example, the interface is a Common Public Radio Interface (CPRI).

For example, the network side device in this embodiment of the present disclosure further includes an instruction or a program that is stored in the memory 95 and that can be run on the processor 94. The processor 94 invokes the instruction or the program in the memory 95 to perform the method performed by the modules shown in FIG. 3, or perform the method in the embodiment of the method for reporting uplink timing adjustment, and same technical effect is achieved. To avoid repetition, details are not described herein again.

An embodiment of this application further provides a readable storage medium. A program or an instruction is stored in the readable storage medium. When the program or the instruction is executed by a processor, the processes of the method embodiment of FIG. 2 or the embodiments of the method for reporting uplink timing adjustment can be implemented, and same technical effect can be achieved. To avoid repetition, details are not described herein again.

The processor is a processor in the terminal or the network side device in the foregoing embodiment. The readable storage medium includes a computer-readable storage medium, such as a computer Read-Only Memory (ROM), a Random Access Memory (RAM), a magnetic disk, or an optical disc.

An embodiment of this application further provides a chip. The chip includes a processor and a communication interface. The communication interface is coupled to the processor, and when the processor is configured to run a program or an instruction of a network side device, the processes of the method embodiment in FIG. 2 are implemented, and same technical effect can be achieved. To avoid repetition, details are not described herein again.

It should be understood that the chip mentioned in this embodiment of this application may also be referred to as a system-level chip, a system chip, a chip system, or a system on chip.

It should be noted that, in this specification, the term “include,” “comprise,” or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application entirely, or the part contributing to the prior art may be implemented in a form of a software product. The computer software product is stored in a storage medium (for example, a ROM/RAM, a magnetic disk, or a compact disc), and includes several instructions for instructing a terminal (which may be a mobile phone, a computer, a server, an air conditioner, a network, or the like) to perform the method described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

1. A positioning method, comprising:
obtaining, by a first network device, target information, wherein the target information comprises: capability information of a terminal,
wherein the capability information of the terminal comprises: a threshold range of receive timing difference between a non-serving cell and a serving cell for supporting Positioning Reference Signal (PRS) processing.

2. The positioning method according to claim 1, wherein the threshold range of receive timing difference between a non-serving cell and a serving cell for supporting Positioning Reference Signal (PRS) processing comprises:
a threshold range of receive timing difference between a non-serving cell and a serving cell for supporting PRS processing under a condition of processing the PRS by using an active Downlink (DL) Bandwidth Part (BWP) or a condition of processing the PRS by using a Measurement Gap (MG).

3. The positioning method according to claim 1, further comprising: initiating, by the first network device, a positioning procedure according to the target information, wherein
the positioning procedure comprises at least one of the following:
sending target indication information to a second network device or the terminal, wherein the target indication information is used to indicate a PRS measurement manner of the terminal;
sending PRS positioning assistance data to the terminal;
sending a location information request to the terminal, wherein the location information request is used to request a PRS measurement result of the terminal; or
performing location calculation, wherein the location calculation is used to calculate a location of the terminal.

4. The positioning method according to claim 1, wherein the target information further comprises:
related information of a serving cell, wherein the related information of the serving cell comprises at least one of the following:
synchronization information of the serving cell, wherein the serving cell comprises at least one of: a primary cell, a primary secondary cell, and a secondary cell;
timing information of the serving cell;
frequency domain location information of the serving cell;
identity information of the serving cell;
activation information of the serving cell;
deactivation information of the serving cell;
adding information of the serving cell; or
release information of the serving cell.

5. The positioning method according to claim 4, wherein the timing information of the serving cell comprises at least one of the following:
a timing difference between the serving cell and the primary cell;
an offset between a system frame 0 of the serving cell and a system frame 0 of the primary cell; or
an absolute time of the system frame 0 of the serving cell.

6. The positioning method according to claim 4, wherein the frequency domain location information of the serving cell comprises at least one of the following:
a frequency location of the serving cell;
a center frequency location of the serving cell;
a carrier bandwidth of the serving cell;
a reference point of the serving cell;
a Subcarrier Spacing (SCS) supported by the serving cell;
a carrier range of the serving cell; or
a band indicator corresponding to the serving cell.

7. The positioning method according to claim 4, wherein the identity information of the serving cell comprises at least one of the following:
a serving cell identity corresponding to the serving cell;
a New Radio Cell Global Identifier (NCGI) corresponding to the serving cell;
a Physical Cell Identifier (PCI) corresponding to the serving cell; or
a band indicator corresponding to the serving cell.

8. The positioning method according to claim 4, wherein before obtaining, by the first network device, the target information, the method further comprises:
sending first request information, wherein the first request information is used to request the related information of the serving cell of the terminal.

9. The positioning method according to claim 8, wherein the first request information comprises at least one of the following:
a request identifier associated with a target parameter in the related information; or
target frequency domain location information, wherein the target frequency domain location information is used to request related information of a serving cell corresponding to a target frequency domain location.

10. The positioning method according to claim 3, wherein the PRS measurement manner indicated by the target indication information comprises: performing PRS measurement on a first target PRS by using an MG, wherein the first target PRS comprises a PRS that is in a non-serving cell of the terminal and that does not meet a PRS measurement condition.

11. The positioning method according to claim 10, wherein the target indication information comprises at least one of the following:
an MG enable identifier; or
positioning frequency layer information of the first target PRS.

12. The positioning method according to claim 3, wherein the PRS measurement manner indicated by the target indication information comprises: when performing PRS measurement by using an active BWP, ignoring measurement on a second target PRS or measurement on a third target PRS, wherein:
the second target PRS comprises at least one of the following:
a PRS of at least one non-serving cell;
a PRS of at least one Transmission and Reception Point (TRP);
a PRS of at least one positioning frequency layer; or
a PRS that is in a non-serving cell and that does not meet a PRS measurement condition, or
the third target PRS comprises at least one of the following:
a PRS of at least one non-serving cell;
a PRS of at least one TRP;
a PRS of at least one positioning frequency layer; or
a PRS that is in a non-serving cell and that meets a PRS measurement condition.

13. The positioning method according to claim 3, wherein the PRS measurement manner indicated by the target indication information comprises:
performing PRS measurement by using an active BWP in when at least one of the following is met that:
all non-serving cells to be measured meet a PRS measurement condition;
the all non-serving cells to be measured are synchronous with a serving cell; or
when the terminal supports a sliding window, ignoring whether the all non-serving cells to be measured meet the PRS measurement condition, or ignoring whether the all non-serving cells to be measured are synchronous with the serving cell.

14. The positioning method according to claim 3, wherein the target indication information is further used to indicate a PRS processing window configuration, and the PRS processing window configuration does not comprise a configuration of a fourth target PRS, or the PRS processing window configuration is not related to the fourth target PRS, wherein the fourth target PRS comprises at least one of the following:
a PRS of at least one non-serving cell;
a PRS of at least one Transmission and Reception Point (TRP);
a PRS of at least one positioning frequency layer; or
a PRS that is in a non-serving cell and that does not meet a PRS measurement condition.

15. The positioning method according to claim 3, wherein the target indication information is further used to indicate at least one of: whether the terminal can request an MG, whether the terminal can request a PRS processing window, whether the second network device has requested the MG, whether the second network device has requested the PRS processing window, a manner in which the terminal requests the MG, and a manner in which the terminal requests the PRS processing window.

16. The positioning method according to claim 1, wherein the capability information of the terminal further comprises at least one of the following:
whether processing a PRS on an active DL BWP is supported;
whether processing the PRS by using an MG is supported;
a processing capability of processing the PRS by using the MG;
a processing capability of processing the PRS by using the active DL BWP;
whether sliding-related processing or Fast Fourier Transform (FFT) processing of the PRS is supported;
whether processing a PRS of a non-synchronous neighboring cell is supported;
whether processing a PRS of a non-serving cell in a manner of ignoring a timing difference threshold is supported; or
a threshold range of receive timing difference between a non-serving cell and a serving cell for supporting PRS processing, under a condition of processing the PRS by using the active DL BWP or a condition of processing the PRS by using the MG.

17. A positioning method, comprising:
sending, by a terminal, target information to a first network device, wherein the target information comprises: capability information of a terminal,
wherein the capability information of the terminal comprises: a threshold range of receive timing difference between a non-serving cell and a serving cell for supporting Positioning Reference Signal (PRS) processing.

18. The positioning method according to claim 17, further comprising: when a PRS measurement condition is met, processing the PRS by using an active Downlink (DL) Bandwidth Part (BWP) or by using a Measurement Gap (MG), wherein the PRS measurement condition comprises that a receive timing difference between the non-serving cell of the terminal and the serving cell of the terminal is less than or equal to the threshold range of the receive timing difference indicated by the capability information of the terminal.

19. A network side device, comprising: a processor; and a memory having a program or an instruction stored therein, wherein the program or the instruction, when executed by the processor, causes the processor to perform the positioning method according to claim 1.

20. A terminal, comprising: a processor; and a memory having a program or an instruction stored therein, wherein the program or the instruction, when executed by the processor, causes the processor to perform operations comprising:
sending target information to a first network device, wherein the target information comprises: capability information of the terminal,
wherein the capability information of the terminal comprises: a threshold range of receive timing difference between a non-serving cell and a serving cell for supporting Positioning Reference Signal (PRS) processing.
